(19) United States
(12) Patent Application Publication
(10) Pub. No.: US 2013/0180595 A1
(43) Pub. Date: Jul. 18, 2013

(54) VESSEL, DISTRIBUTION TRAY, AND METHOD FOR PASSING ONE OR MORE FLUIDS

(71) Applicants: Christopher Naunheimer, Arlington Heights, IL (US); Zhanping Xu, Inverness, IL (US)

(72) Inventors: Christopher Naunheimer, Arlington Heights, IL (US); Zhanping Xu, Inverness, IL (US)

(73) Assignee: UOP, LLC, Des Plaines, IL (US)

(21) Appl. No.: 13/350,473

(22) Filed: Jan. 13, 2012

(51) Int. Cl. F15D 1/00; B01J 8/02; B01J 19/00

(52) U.S. Cl. 137/13; 422/310; 422/211

(57) ABSTRACT

One exemplary embodiment can be a method passing one or more fluids through a compartment. The method may include collecting a liquid on a tray, passing a vapor through the compartment, and mixing the vapor with the liquid entering the compartment via at least one aperture to impart swirling to the vapor and liquid exiting the compartment. Also, the compartment can include or consist of an interior wall and an exterior wall, and generally the compartment at least partially forms rifling on the interior wall.

### FIELD OF THE INVENTION

The present invention generally relates to a vessel, distribution tray, and method for passing one or more fluids through a compartment.

### DESCRIPTION OF THE RELATED ART

Various vessels can be used in chemical processing, petroleum refining, and other industries for distributing fluids, particularly a mixed phase fluid of liquid and gas over beds or trays. One particular vessel can be a reactor, such as a trickle flow reactor, which can be used in processes such as catalytic dewaxing, hydrotreating, hydrodesulfurizing, hydrofinishing, and hydrocracking. Generally, a feed, such as a fluid including one or more liquids and gases, can pass over a particulate catalyst contained in a packed bed in a downflow reactor. Chemical reactions can take place that may produce additional components in a gas phase, such as hydrogen sulfide and ammonia, in some hydrotreating processes. Such gases and liquids typically flow downward through the packed bed and exit a bottom outlet.

To facilitate reactions, a solid catalyst is often arrayed in a plurality of beds with a distributor plate or tray above each bed for the purpose of uniformly, effectively, and efficiently distributing the fluid at the top of the bed.

Often, low pressure drop distributors may utilize high distributor density to provide liquid “microdistribution” across the top of a downstream bed. Many high pressure drop distributors utilize low distributor density coupled with an impingement, i.e., splash plate, to provide liquid “microdistribution” across the top of a downstream bed. Typically, low distributor density allows for easier maintenance and access between vapor liquid distributors on the top side of the vapor liquid tray, and may be preferable. However, the impingement splash plate can be required, which may be an additional component that can have unpredictable performance at varying reactor conditions and may limit access to the inside of the vapor-liquid distributor from the bottom side of the vapor-liquid distribution tray.

Also, distributors can have liquid holes on a single side. The side forming the hole may permit liquid to enter and allow most of the liquid to flow down along the other side of the distributor. This flow down a single side can create an uneven liquid flow out of the distributor, and impede reactions in the bed below. This uneven flow may be balanced by using internal orifices. However, such internal orifices can suffer a disadvantage of creating a high pressure drop.

Therefore, there is a desire to provide an improved distributor that can improve mixing of vapor-liquid passing through therein without additional devices, such as an impingement splash plate.

### SUMMARY OF THE INVENTION

One exemplary embodiment can be a method passing one or more fluids through a compartment. The method may include collecting a liquid on a tray, passing a vapor through the compartment, and mixing the vapor with the liquid entering the compartment via at least one aperture to impart swirling to the vapor and liquid exiting the compartment. Also, the compartment can include or consist of an interior wall and an exterior wall, and generally the compartment at least partially forms rifling on the interior wall.

Another exemplary embodiment may be a distribution tray for a vessel. The distribution tray can include a member forming a first side and a second side, and a compartment coupled to the member with a first portion protruding from the first side and adapted to permit passage of a fluid from the first side to the second side of the member. Often, the compartment includes or consists of an interior wall at least partially forming rifling and the first side is adapted to receive a liquid thereon, and forming a plurality of openings.

A further exemplary embodiment may be a vessel. The vessel may include an inlet, an outlet, a distribution tray including a member having a first side and a second side, a compartment coupled to the member, and a packed bed including particles. Often, the compartment includes or consists of an exterior wall and an interior wall at least partially forming rifling.

The embodiments disclosed herein can eliminate the need for an impingement splash plate by imparting a spin to the vapor-liquid mixture exiting a compartment. Not only does this spin promote mixing between the two phases, but the spin may cause the liquid to “spray” out as it reaches a point just past the outlet opening of the compartment. This imparted spin can eliminate the need for extra devices, such as an impingement splash plate. The rifling of at least a portion of the compartment can impart spin to the fluids similarly as rifling of a barrel imparts spin to a projectile. These helical grooves and/or lands of the rifling can be added to a portion, or the entire length of, an internal surface of a vapor-liquid compartment. Thus, the rifling may impart a spin to the vapor-liquid mixture inside the compartment and impart a spray as the fluids exit the compartment.

### DEFINITIONS

As used herein, the term “stream” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “coupled” can mean two items, directly or indirectly, joined, fastened, associated, connected, or formed integrally together either by chemical or mechanical means, by processes including stamping, molding, or welding. What is more, two items can be coupled by the use of a third component such as a mechanical fastener, e.g. a screw, a nail, a staple, or a rivet; an adhesive; or a solder.

As used herein, the term “fluid” can mean one or more gases, one or more liquids, and/or one or more vapors.

As used herein, the term “gas” can mean a single gas or a solution of a plurality of gases.

As used herein, the term “liquid” can mean a single liquid, or a solution or a suspension of one or more liquids with one or more gases and/or solid particles.

As used herein, the term “vapor” can mean a gas or a dispersion that may include or consist of one or more hydrocarbons. A dispersion may include one or more of a gas, a liquid, and a solid, such as a dispersion of an aerosol and/or a fog.

As used herein, the term “absorption” can collectively refer to several processes, including adsorbing and absorbing.

### BRIEF DESCRIPTION OF THE DRAWINGS

FIG. 1 is an elevational, cross-sectional view of an exemplary vessel.

FIG. 2 is a perspective view of an exemplary tray.

FIG. 3 is an elevational, cross-sectional view of an exemplary compartment.

FIG. 4 is an elevational, cross-sectional view of a further exemplary compartment.

FIG. 5 is an elevational, cross-sectional view of a yet another exemplary compartment.

FIG. 6 is an elevational, cross-sectional view of still another exemplary compartment.

FIG. 7 is a bottom, plan view of the still another exemplary compartment.

FIG. 8 is an elevational, cross-sectional view of yet a further exemplary compartment.

FIG. 9 is an elevational, cross-section view of a still further exemplary compartment.

### DETAILED DESCRIPTION

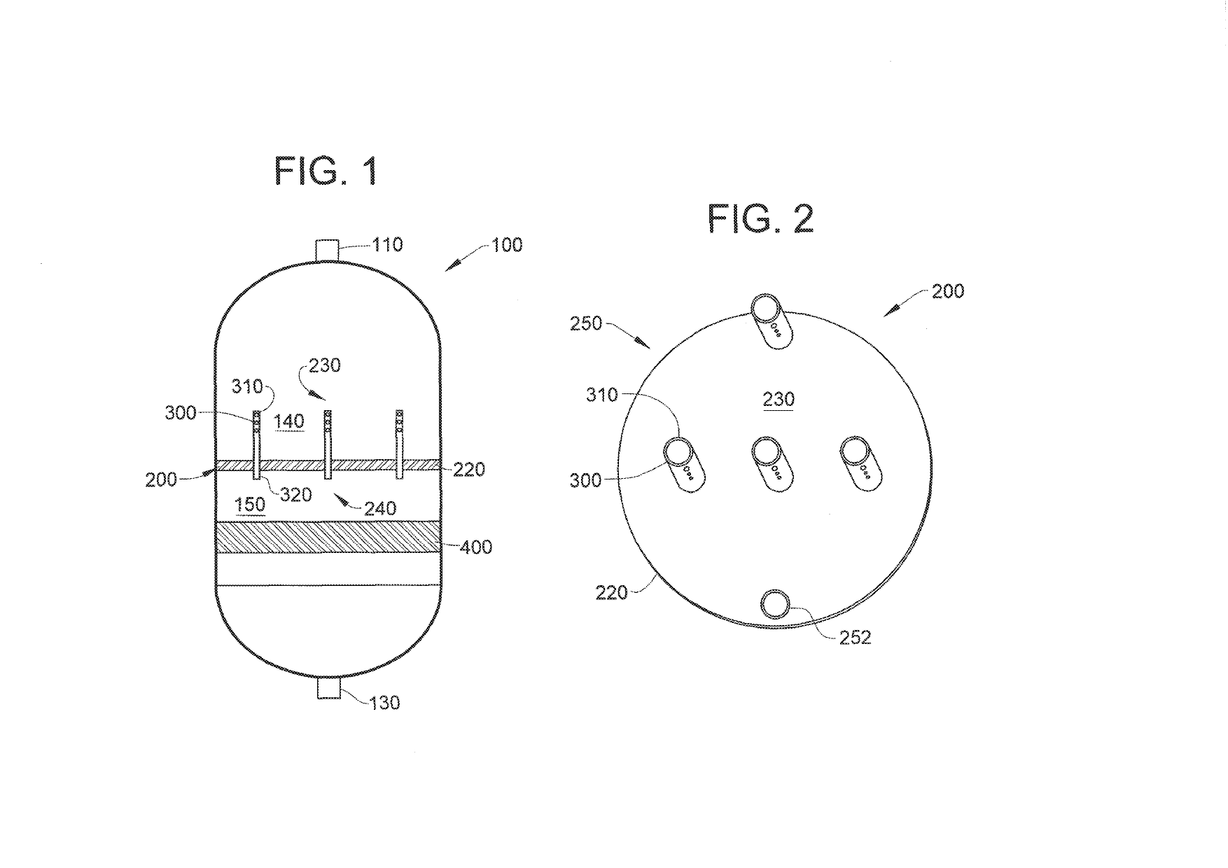

Referring to FIGS. 1-2, an exemplary vessel 100 is depicted having an inlet 110 and an outlet 130. The vessel 100 can receive a feed of a fluid or fluids, including a liquid or a mixed phase fluid, such as one or more liquids and gases, through the inlet 110. The feed can often be a fluid including one or more liquids and one or more vapors. Usually, the feed includes one or more hydrocarbons present as liquid droplets entrained in a gas including hydrogen, methane, and/or ethane. Generally, the feed is distributed in the vessel 100 containing a packed bed 400 of particles, such as a catalyst. Although a reactor is disclosed herein, it should be understood that other types of vessels such as an absorber or a mass transfer vessel can also use the embodiments disclosed herein, and other materials can be contained instead of or in addition to the catalyst, such as an absorbent. Furthermore, the vessel 100 can be manufactured from any suitable material, such as carbon or stainless steel.

The vessel 100 can include a distribution tray 200 and the packed bed 400 of particles, such as a catalyst. Although only one distribution tray 200 and one packed bed 400 are depicted in this exemplary embodiment, it should be understood that the vessel 100 can contain any number of distribution trays 200 and packed beds 400. An exemplary vessel including multiple packed beds is disclosed in, e.g., US 2006/0163758 A1. In addition, although a feed is discussed as being distributed, any stream or fluid may be distributed, including intermediate streams internal to the vessel 100 or recycle streams.

The distribution tray 200 can include a member 220 having a first side 230 and a second side 240, and at least one compartment 300 for facilitating co-current downflow. The distribution tray 200 can divide the vessel 100 into a region 140 above the distribution tray 200 and another region 150 below the distribution tray 200. The at least one compartment 300 may include a first portion 310 protruding from the first side 230 and a second portion 320 protruding from the second side 240. Although the member 220 is depicted as circular, it should be understood that the member 220 can take any suitable shape. Generally, the member 220 is impermeable to fluid except wherein the member 220 forms openings 250, and substantially occupying a cross-sectional area of the vessel 100.

Typically, the distribution tray 200 includes at least one compartment 300 that allows the passage of a fluid, such as a liquid and/or a vapor there-through. The compartments 300 can be arranged in any suitable pattern on and coupled to the member 220. In this exemplary embodiment, a plurality of four compartments 300 are depicted, however, any suitable number of compartments 300 can be utilized. Although the compartments 300 are depicted as uncapped, it should be understood that any suitable cap can be utilized, independently, with the compartments 300. In addition, the member 220 can form a plurality of openings 250, as illustrated by an opening 252 with the other openings occupied by a respective compartment. Typically, any opening 252 in the member 220 is adapted to receive a compartment as any unoccupied opening 252 may be susceptible to plugging. As such, the opening 252 is depicted without a compartment 300 for illustrative purposes only and would typically be occupied by a compartment 300 therein. Moreover, it should be understood that each compartment 300 can be the same or different from, respectively, other compartments. In this exemplary embodiment, the compartments 300 can be substantially identical, so only one may be described in particular detail.

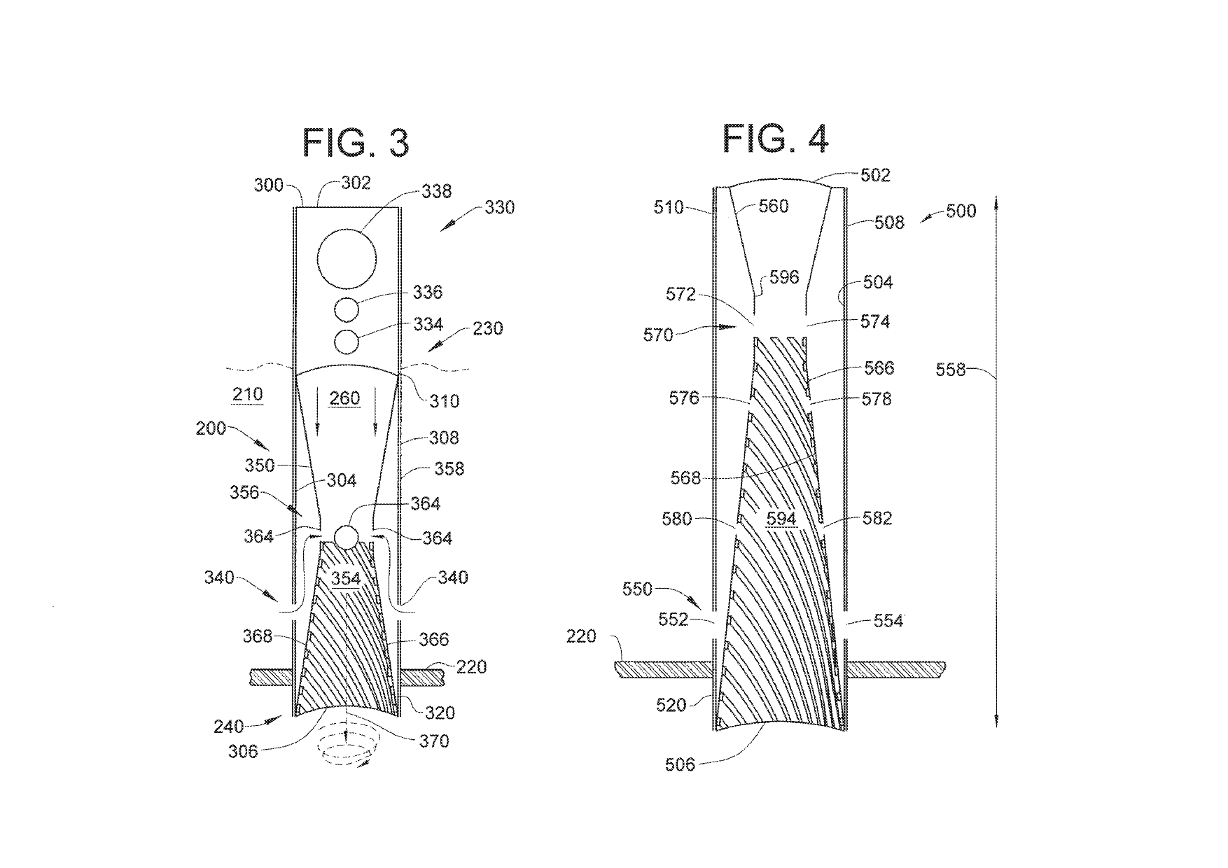

Referring to FIG. 3, an exemplary compartment 300 is depicted. The compartment 300 can take any suitable shape, such as a tube, a prism, an octagonal structure, or any other suitable shape. In this exemplary embodiment, the compartment 300 can include or consist of an inlet 302 and an outlet 306, and extend through the member 220 including a first portion 310 protruding from the first side 230 and a second portion 320 protruding from the second side 240. Moreover, the compartment 300 can form or consist of an interior wall 304 and an exterior wall 308 typically forming a tube 358 although any suitable shape may be utilized. Generally, the compartment 300 can form a plurality of apertures 330 including a first aperture 334, a second aperture 336, and a third aperture 338 at or above a constriction 356. A liquid 210 on the member 220 can pass into the compartment 300 through a plurality of openings 340, or as the liquid 210 rises, can pass through one or more of the plurality of apertures 330. In addition, the compartment 300 can form a plurality of openings 340 below the constriction 356.

Furthermore, the compartment 300 can receive or consist of an insert 350 positioned within the compartment 300. Generally, the insert 350 forms a substantially venturi-shaped throat inside the tube 358. The insert 350 can form a constriction 356 inside the tube 358 and include or consist of another interior wall 366. One or more apertures 364 can be formed at the constriction 356. Below the constriction 356, another interior wall 366 can form or consist of rifling 368 about a center 370. This rifling 368 can impart spin or swirl to a vapor 260 and/or liquid passing through and exiting the compartment 300 to a packed bed below. The rifling 368 can be formed on all or a portion of the another interior wall 366 and/or all or a portion of the interior wall 304.

The rifling 368 can include one or more curved irregularities formed on an interior 354 on the another interior wall 366. Generally, the curved irregularities can be formed by any suitable process, such as grinding, rolling, or extruding. As a result, one or more grooves may be formed between one or more ridges forming a helical pattern, although any suitable pattern may be formed. Although the one or more curved irregularities can be one or more grooves or one or more ridges, preferably a combination of such structures are formed. Procedures for making grooves and/or ridges inside a tube are disclosed in, e.g., U.S. Pat. No. 2,181,927, U.S. Pat. No. 3,559,437, U.S. Pat. No. 3,847,212, and US 2005/0145377 A1. The rifling 368 disclosed herein can be substantially similar to those used in other embodiments disclosed below.

Referring to FIG. 4, a further exemplary embodiment of a compartment 500 having a first portion 510 and a second portion 520 with the first portion 510 typically protruding above and the second portion 520 usually protruding below the member 220. The compartment 500 can include or consist of an inlet 502 and an outlet 506, have or consist of an interior wall 504 and an exterior wall 508, and have or consist of a height 558. Generally, an insert 560 is positioned within the compartment 500. The compartment 500 can form a plurality of openings 550 having a first opening 552 and a second opening 554. Usually the openings 550 are equally spaced around the periphery of the compartment 500.

In turn, the insert 560 can form one or more openings 570, including openings 572 and 574 at a first or highest elevation, openings 576 and 578 at a second or middle elevation; and openings 580 and 582 at a third or lowest elevation. Generally, the insert 560 forms a substantially venturi-shaped throat inside the compartment 500 and a constriction 596. Typically, the constriction 596 is formed in the upper half, preferably the upper third, of the compartment 500. The openings 572 and 574 can be at or below the constriction 596. Usually, the total area of the plurality of openings 550 is greater than the total area of the one or more openings 570. As such, the one or more openings 570 can control the flow of liquid into the insert 560. As liquid rises within the walls of the compartment 500, the liquid can pass incrementally through the openings 570 with increasing liquid flow as the elevation of the liquid rises and passes openings 580 and 582, then openings 576 and 578, and even openings 572 and 574. The compartment 500 containing an insert 560 can be fabricated in a similar manner as described above for the distribution tray 200 in FIGS. 1-2, and operate similarly as described above.

The another interior wall 566 can form rifling 568 on an interior 594 from the openings 572 and 574 to the outlet 506 of the compartment 500. Although the rifling 568 is depicted as extending from the openings 572 and 574 to the outlet 506, it should be understood that the rifling 568 can extend the entire length of the insert 560 or only a portion thereof, and/or a portion or all of the interior wall 504.

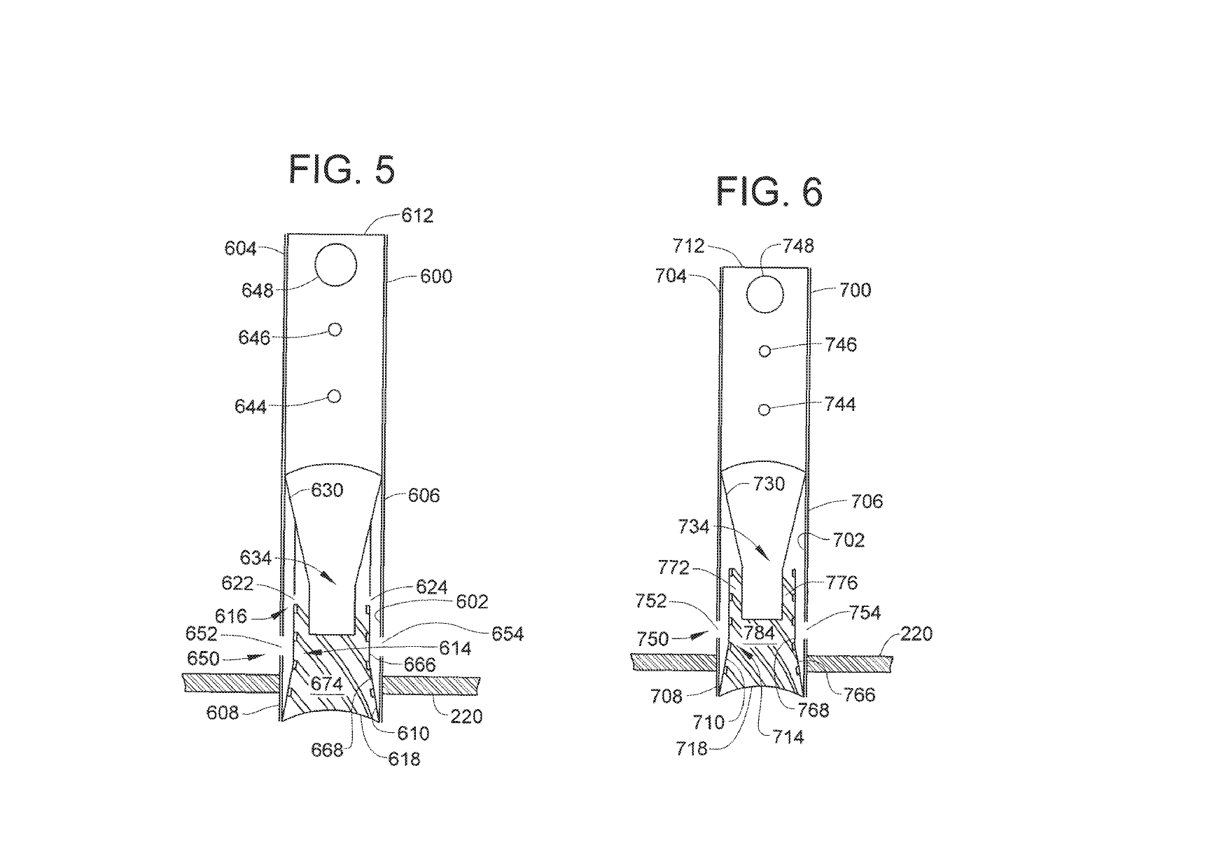

Referring to FIG. 5, yet another exemplary embodiment of a compartment 600 can include or consist of an inlet 612 and an outlet 618, and have or consist of a first portion 604 and a second portion 608 with the first portion 604 typically protruding above and the second portion 608 usually protruding below the member 220. Also, the compartment 600 may have or consist of an interior wall 602 and an exterior wall 606. Generally, a first insert 610 and a second insert 630 are positioned within the compartment 600. Typically, the first insert 610 can be an inverted funnel and the second insert 630 can be a funnel. The inserts 610 and 630 can form respective constrictions 614 and 634 with at least a portion of the second insert 630 in an opposing, nested relationship with at least a portion of the first insert 610. Generally, a diameter of a tube of the first insert 610 is dimensioned for receiving a tube and optionally at least a portion of a cone of the second insert 630. The compartment 600 can form a plurality of openings 650 having a first opening 652 and a second opening 654. Typically the openings 650 are equally spaced around the periphery of the compartment 600.

The first insert 610 can form one or more openings 616, including openings 622 and 624 at an elevation higher than the openings 652 and 654. Generally, the first insert 610 and the second insert 630 are inside the compartment 600. As liquid enters the openings 652 and 654, the liquid can rise and flow through the openings 622 and 624 interacting with a gas flowing downward through the compartment 600 and passing through the constriction 634. Hence, the liquid may take a winding path through the inserts 610 and 630 collectively forming an annular passage in the compartment 600. If excessive liquid is on the member 220, the liquid may pass through an aperture 644, an aperture 646, or even an aperture 648. The compartment 600 containing the inserts 610 and 630 can be fabricated in a similar manner as described above for the distribution tray 200, and can operate similarly as described above.

Typically, rifling 668 can be present in an interior 674 on another wall 666 of the first insert 610. Generally, the rifling 668 extends from the first opening 622 and the second opening 624 to the outlet 618, although the rifling 668 can extend along any height of the interior wall 666. Moreover, the rifling 668 may also be present instead of or additionally in the interior walls of the second insert 630 and/or the interior wall 602 of the another compartment 600.

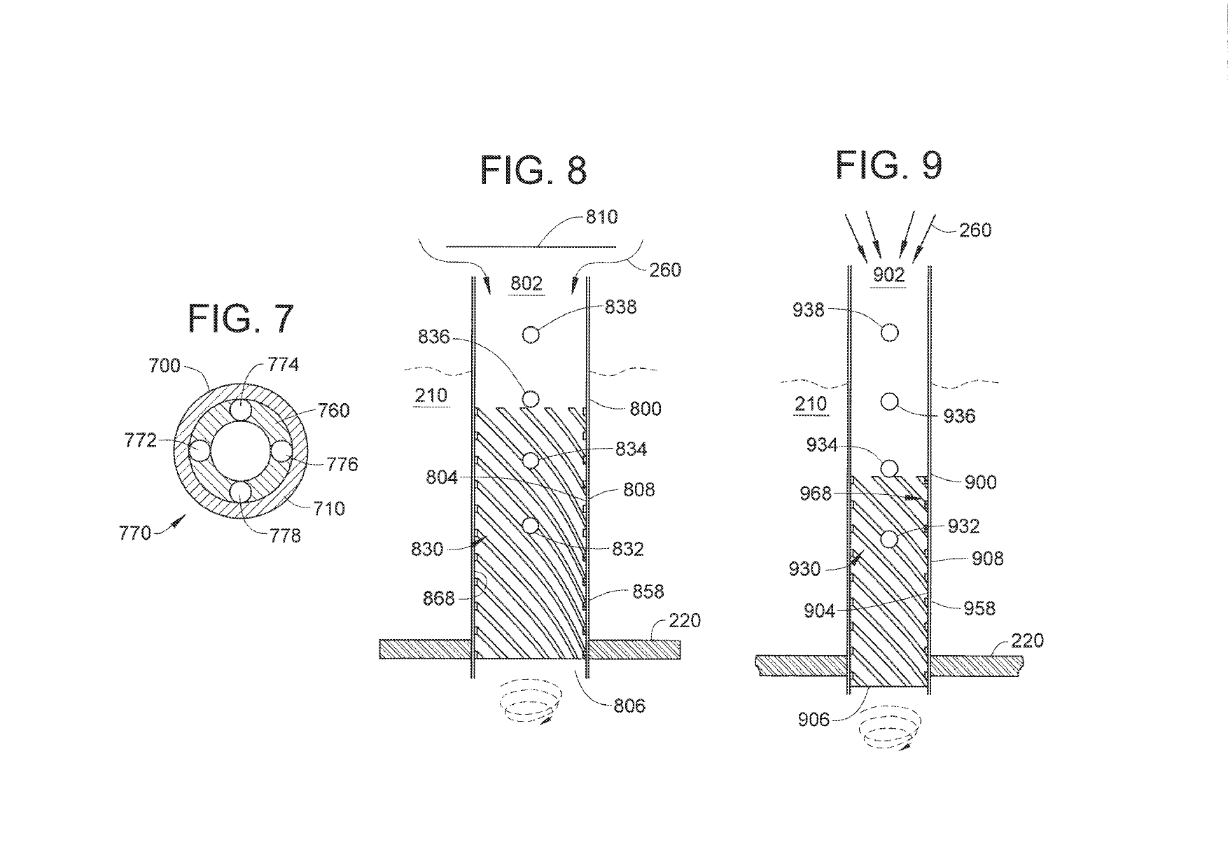

Referring to FIGS. 6-7, still another exemplary embodiment of a compartment 700 can include or consist of an inlet 712 and an outlet 718, and have or consist of a first portion 704 and a second portion 708 with the first portion 704 typically protruding above and the second portion 708 usually protruding below the member 220. Also, the compartment 700 may have an interior wall 702 and an exterior wall 706. Generally, a first insert 710 and a second insert 730 are positioned within the compartment 700. Usually, the first insert 710 can be an inverted funnel shape and the second insert 730 can be a funnel shape. The inserts 710 and 730 can form respective constrictions 714 and 734 with at least a portion of the second insert 730 in an opposing, nested relationship with at least a portion of the first insert 710. Generally, a diameter of a tube of the first insert 710 is dimensioned for receiving a tube and optionally at least a portion of a cone of the second insert 730. The compartment 700 can form a plurality of openings 750 having a first opening 752 and a second opening 754. Usually the openings 750 are equally spaced around the periphery of the compartment 700.

The first insert 710 can terminate at elevation to form a winding pathway between the inserts 710 and 730. A plug 760 forming a plurality of orifices 770, namely orifices 772, 774, 776, and 778, can be positioned between the inserts 710 and 730 and regulate the liquid flow there-between. Generally, the first insert 710 forms a constriction 714 and the second insert 730 forms a constriction 734 inside the compartment 700. As liquid enters the openings 752 and 754, the liquid can rise and flow through the plurality of orifices 770 interacting with a gas flowing downward through the compartment 700 and passing through the constriction 734. Hence, the liquid may take a winding path through the compartment 700. If excessive liquid is on the member 220, the liquid may pass through an aperture 744, an aperture 746, or even an aperture 748. The compartment 700 containing the inserts 710 and 730 can be fabricated in a similar manner as described above for the distribution tray 200, and can operate similarly as described above.

Rifling 768 can extend along the entire height of the first insert 710, although the rifling may be present along any suitable length of the first insert 710. Moreover, the rifling 768 may be present instead or additionally on the interior wall 702 of the yet another compartment 700 and/or the interior of the second insert 730. Generally, the rifling 768 may be present along any suitable interior surface of the compartment 700, the first insert 710 and the second insert 730. In this exemplary embodiment, the rifling 768 may be present in an interior 784 on another interior wall 766 of the second insert 730. In this exemplary embodiment, the rifling 768 may be present in an interior 784 on another interior wall 766 of the first insert 710.

Referring to FIGS. 8-9, a liquid 210 level is depicted to further illustrate the operations of the embodiments disclosed herein. Referring specifically to FIG. 8, yet a further compartment 800 can include or consist of an inlet 802 and an outlet 806, as well as an interior wall 804 and exterior wall 808. Generally, a plate 810, which can be a circular cap, can be positioned above the inlet 802 of the compartment 800. Usually, the compartment 800 can form a tube 858. Generally, the compartment 800 can form a plurality of apertures 830, namely a first aperture 832, a second aperture 834, a third aperture 836, and a fourth aperture 838. The rifling 868 may be formed along the interior 804 of the compartment 800, and in this exemplary embodiment may extend from below the third aperture 836 to the outlet 806. However, it should be understood that the rifling 868 may extend any suitable length, such as below the first aperture 832 to the outlet 806 or along the entire interior 804 of the compartment 800. As depicted in FIG. 8, the vapor 260 can enter the inlet 802 and exit the outlet 806 with an imparted swirling motion.

Referring to FIG. 9, a still further compartment 900 can have or consist of an inlet 902 and an outlet 906, and have or consist of an interior wall 904 and an exterior wall 908. Generally, the compartment 900 can form a plurality of apertures 930, such as a first aperture 932, a second aperture 934, a third aperture 936, and a fourth aperture 938. Usually, the compartment 900 forms a tube 958. Typically, rifling 968 extends below the second aperture 934 to the outlet 906, although the rifling 968 may extend any suitable length. As depicted in FIG. 9, the vapor 260 can enter the inlet 902 and exit the outlet 906 with an imparted swirling motion, similarly as discussed above. Exemplary compartments absent rifling are disclosed in, e.g., U.S. Pat. No. 7,506,861.

Although vapor 260 is not depicted in FIGS. 4-6, it should be understood that the vapor can enter an inlet and exit the outlet with an imparted swirling motion similarly as depicted in FIGS. 3, and 8-9. For compartments having liquid holes only on one side of the compartment, such as disclosed in, e.g., U.S. Pat. No. 7,506,861, rifling can be provided to disperse the non-uniform liquid flow. Therefore, providing helical grooves inside of distributors with only holes on a single side, such as those disclosed at FIG. 5B of U.S. Pat. No. 7,506,861 can create an even flow without the requirement of internal orifices while reducing the pressure drop required for the liquid entering the compartment. Generally, the vapor rate is relatively constant over the range of hydroprocessing operating conditions, and if the vapor plays a significant role in imparting the spin, the device may be relatively insensitive to a liquid rate in regards to spray effectiveness, i.e., the area covered by the distribution tray.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A method passing one or more fluids through a compartment, comprising:
A) collecting a liquid on a tray wherein the tray comprises the compartment wherein the compartment comprises an interior wall and an exterior wall, and the compartment at least partially forms rifling on the interior wall;
B) passing a vapor through the compartment; and
C) mixing the vapor with the liquid entering the compartment via at least one aperture to impart swirling to at least one of the vapor and liquid exiting the compartment.

2. The method according to claim 1, wherein the compartment forms a plurality of apertures wherein the plurality of apertures are formed at different elevations along a height of the compartment.

3. The method according to claim 1, wherein the liquid comprises one or more hydrocarbons and the vapor comprises hydrogen.

4. The method according to claim 1, wherein at least a portion of the vapor and liquid swirl exiting the compartment.

5. The method according to claim 1, wherein the vapor and liquid pass downward to exit the compartment.

6. The method according to claim 1, further comprising passing the vapor and liquid from the compartment to a packed bed comprising one or more particles below.

7. The method according to claim 1, wherein the compartment forms a tube, and the tube comprises the interior wall.

8. The method according to claim 1, wherein the compartment further comprises an insert having the interior wall.

9. The method according to claim 1, wherein the compartment further comprises first and second inserts wherein the second insert comprises the interior wall.

10. A distribution tray for a vessel, comprising:
A) a member forming a first side and a second side wherein the first side is adapted to receive a liquid thereon, and forming a plurality of openings; and
B) a compartment coupled to the member with a first portion protruding from the first side and adapted to permit passage of a fluid from the first side to the second side of the member wherein the compartment comprises an interior wall at least partially forming rifling.

11. The distribution tray according to claim 10, wherein the compartment forms a tube wherein the tube comprises the interior wall.

12. The distribution tray according to claim 10, wherein the compartment forms a plurality of apertures at different elevations for permitting a fluid to pass there-through.

13. The distribution tray according to claim 10, wherein the compartment comprises an insert positioned within the compartment to constrict and then expand a passage of the fluid there-through and the insert comprises the interior wall.

14. The distribution tray according to claim 10, wherein the compartment forms a tube, and the tube comprises the interior wall.

15. The distribution tray according to claim 13, wherein the insert is a first insert and the compartment further comprises a second insert wherein the second insert comprises the interior wall.

16. The distribution tray according to claim 15, wherein the first and second inserts are in an opposing, nested relationship.

17. A vessel, comprising:
A) an inlet;
B) an outlet;
C) a distribution tray, comprising a member having a first side and a second side;
D) a compartment coupled to the member wherein the compartment comprises an exterior wall and an interior wall at least partially forming rifling; and
E) a packed bed comprising particles.

18. The vessel according to claim 17, wherein the compartment forms a plurality of apertures wherein the plurality of apertures are formed at different elevations along a height of the compartment.

19. The vessel according to claim 17, wherein the compartment further comprises an insert positioned within the compartment to constrict and then expand a passage of a fluid there-through and the insert comprises the interior wall.

20. The vessel according to claim 17, wherein the compartment forms a tube having the interior wall.
